(19) United States
(12) Patent Application Publication
(10) Pub. No.: US 2010/0200792 A1
(43) Pub. Date: Aug. 12, 2010

(54) RAIN HAT DEVICE FOR HEAVY CONSTRUCTION EQUIPMENT

(75) Inventors: Toshimichi Ikeda, Changwon-si (KR); Gyen Soo Cho, Masan-si (KR); Kyu Cheon Jeong, Changwon-si (KR); Syeong Ho Choi, Changwon-si (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: VOLVO CONSTRUCTION EQUIPMENT HOLDING SWEDEN AB

(21) Appl. No.: 12/702,712

(22) Filed: Feb. 9, 2010

(30) Foreign Application Priority Data
Feb. 11, 2009 (KR) 10-2009-0011047

(51) Int. Cl. F16K 1/16; A47J 27/09

(52) U.S. Cl. 251/301; 251/338

(57) ABSTRACT

A rain hat device for heavy construction equipment which is installed adjacent to an exhaust gas discharging port of a distal end portion of an exhaust pipe to prevent inflow of rainwater therein is disclosed. The rain hat device comprises a swing cover installed at a distal end portion of the exhaust pipe in a spaced and floated state so as to prevent rainwater from flowing in the distal end portion of the exhaust pipe, and in which the swing cover does not come into contact with the distal end portion of the exhaust pipe to prevent noise from being generated due to contact and collision when an engine stops or exhaust gas is not discharged.

### CROSS-REFERENCE TO RELATED APPLICATION

This application is based on and claims priority from Korean Patent Application No. 10-2009-0011047, filed on Feb. 11, 2009, in the Korean Intellectual Property Office, the disclosure of which is incorporated herein in its entirety by reference.

### FIELD OF THE DISCLOSURE

The present disclosure relates to a rain hat device for heavy construction equipment, and more particularly, to a rain hat device for heavy construction equipment, in which a swing cover is installed at a distal end portion of an exhaust pipe in a spaced and floated state so as to prevent rainwater from flowing in the distal end portion of the exhaust pipe, and in which the swing cover does not come into contact with the distal end portion of the exhaust pipe to prevent noise from being generated due to contact and collision when an engine stops or exhaust gas is not discharged.

### BACKGROUND OF THE DISCLOSURE

FIG. 1 shows a side view illustrating an excavator of a related art.

Referring to FIG. 1, reference numeral 101 denotes an upper swing structure, 102 denotes a working device, 104 denotes an engine room, 105 denotes an exhaust pipe for discharging exhaust gas from the engine, and 118 denotes a cabin. The working device 103 includes a boom 10, a boom cylinder 9, an arm 12, an arm cylinder 11, a bucket 14 and a bucket cylinder 13. Further, the upper swing structure 101 can be swung on the lower driving structure 102 by a swing motor (not shown).

The exhaust pipe 105 generally includes a bent distal end portion, through which gas is charged, so as to prevent rainwater from flowing therein.

When a large-sized excavator or a loader is carried, the overall height of the machine is configured to be within a transport limit dimension which is set forth in regulations. In this instance, the front working device 103 has to be disassembled from the machine. Since the cabin 118 is difficult to be disassembled from the machine, the machine with the cabin mounted thereon is designed so as to meet the transport limit dimension. However, in the case of the exhaust pipe 105, the height of the exhaust pipe is higher than the cabin 118, the exhaust pipe has to be disassembled from the machine for the purpose of the transport. It is remarkably inconvenient and cumbersome. For this reason, it has attempted to shorten the exhaust pipe 105 even though the exhaust gas is discharged upwardly, but the rainwater flows in a discharging port 106a of the exhaust pipe. As shown in FIG. 2, therefore, a rain hat 20 is provided as a rainwater ingression-preventing device, as shown in FIG. 2.

FIG. 2 is a view schematically illustrating a rain hat device for heavy construction equipment according to a related art, in which FIG. 2A is a partial cross-sectional view of a rain hat connected to a distal end portion of an exhaust pipe, and FIG. 2B is a side view of the rail hat connected to the exhaust pipe shown in FIG. 2A.

Explaining the rain hat in detail with reference to FIG. 2, the rain hat 20 includes a swing lever 22, a cap 23, a weight portion 24, a pivot support pin 25, a support bracket 26, an exhaust pipe fixing portion 27, and a fixing bolt 28. With the rail hat 20 of the related art, the support bracket 26 is placed at one side of the distal end portion 106 of the exhaust pipe 105, and then is fixed thereto by the fixing bolt 28.

The swing lever is rotated around the pivot support pin 25 in a counterclockwise direction, as seen in the figure, together with the cap 23 and the weight portion 24. Thus, the cap 23 of the rain hat 20 comes in contact with the outlet portion of the distal end portion 106, and the cap 23 is seated on one side surface of the exhaust pipe 105.

Since the distal end portion 106 of the exhaust pipe 105 is adjacent to the lateral surface forming the exhaust gas discharging port 106a, it seems that the cap 23 of the rain hat 23 is seated on the distal end portion 106 adjacent to the distal end portion 106 of the exhaust pipe 105.

FIG. 3 is a view illustrating the operation of the rain hat device for heavy construction equipment according to the related art shown in FIG. 2. Reference numeral 30 shows schematically a flow of the exhaust gas discharged at fast speed through the distal end portion 106 of the exhaust pipe 105 and the discharging port when the engine is driven. The cap 23 is upwardly pushed by dynamic spray force of the exhaust gas 30, and then is rotated in a counterclockwise direction, so that the distal end portion 106 of the exhaust pipe 105 and the exhaust gas discharging port 106a are opened. The exhaust gas 30 is discharged outwardly from the exhaust pipe 105, and simultaneously, the cap 23 is continuously maintained at a position higher than the distal end portion 106 of the exhaust pipe 105 and the discharging port by the dynamic pressure.

In the conventional rain hat device for heavy construction equipment, the weight portion 24 and the swing lever 22 which are rotated together with the cap 23 serve as an operating unit of the rain hat 20. When the engine stops, the dynamic force of the exhaust gas disappears, and thus the cap 23 and the operating unit are rotated in a clockwise direction by its own weight and are returned to the position in which the inner surface 21 comes in contact with the distal end portion 106 of the exhaust pipe 105 and the exhaust gas discharging port 106a, so that the cap and the operating unit are seated on the exhaust gas discharging port 106a.

Explaining the operating with reference to FIGS. 2 and 3, the weight center G1 of the swing lever 22 and the weight portion 24 which serve as the operating unit of the rain hat 20 is positioned in a first section A formed between the pivot pin 25 and the cap 23. Supposing that the weight of the operating unit is W, since the rotational moment M of the operating unit acts as a force of M=W×A, the operating unit tries to rotate in the clockwise direction, the cap 23 comes in contact with the end face of the distal end portion 106 of the exhaust pipe 105 to maintain the exhaust gas discharging port 106a in a sealing state.

That is, the cap 23 has a role of blocking inflow of the rainwater by closing the end face of the exhaust gas discharging port 106a.

If the exhaust gas 30 is discharged by driving of the engine, the dynamic discharging pressure of the exhaust gas overcomes the rotational moment of the operating unit and the cap 23 to push the cap 23 in the counterclockwise direction on the figure.

In this instance, the weight center G1 of the operating unit including the cap 23 is moved to the upward side of the pivot pin 25, and thus the weight center G1 is changed to the weight center G2 in a second section B. After that, if the engine stops, the pressure of the exhaust gas pushing the cap 23 upwardly disappears, the cap 23 and the swing lever 22 are rotated in the clockwise direction, so that the weight center is changed to the initial position G1.

According to the conventional rain hat device for heavy construction equipment, the cap 23 is maintained in a floating state in the air by the pressure generated by the exhaust gas discharged at the high speed. However, since the pressure of the exhaust gas is lower than the rotational moment M when the engine is idling or the engine stops, the inner surface 21 of the cap 23 contacts the distal end portion 106 of the exhaust pipe 105 to generate noise.

There is a subsidiary problem in that a driver or a worker suffers from the noise, and thus a working efficiency is deteriorated.

In addition, in the case of the large-sized excavator, since the distal end portion 106 of the exhaust pipe 105 is extended, work efforts remarkably increase, for example, cumbersome disassembling/assembling process is required for the transport thereof.

### SUMMARY OF THE DISCLOSURE

Accordingly, the present disclosure has been made to solve the above-mentioned problems occurring in the prior art while advantages achieved by the prior art are maintained intact.

One subject to be solved by the present disclosure is to provide a rain hat device for heavy construction equipment, in which a weight center of a swing cover including a cover support portion and a weight is placed below a fixing shaft even though an engine stops or the engine is idling, so that the swing cover does not contact or collide against the distal end of an exhaust pipe and an exhaust gas discharging port, thereby preventing mechanical noise such as rattling noise from being generated repeatedly.

In order to accomplish the subject, there is provided a rain hat device for heavy construction equipment which is installed adjacent to an exhaust gas discharging port of a distal end portion of an exhaust pipe to prevent inflow of rainwater therein, the rain hat device including a mounting bracket having a fixing shaft which is installed on an upper portion of the exhaust gas discharging port of the distal end portion of the exhaust pipe, the mounting bracket fixing the fixing shaft at a position higher than the distal end portion of the exhaust pipe; and a swing cover having a cover support portion connected to the fixing shaft and extending between the fixing shaft and the exhaust gas discharging port, and a weight portion, in which the cover support portion is rotated around the fixing shaft by pressure of exhaust gas discharged from the distal end portion, wherein the swing cover is installed on an upper portion of the exhaust gas discharging port in a floating state by the cover support portion so that a weight center is positioned between the fixing shaft and the exhaust gas discharging port when the discharging pressure of the exhaust gas is generated.

The mounting bracket is provided at one side thereof with a clamp member for connecting the mounting bracket to the distal end portion of the exhaust pipe.

Further, the mounting bracket is fixed to one side of an engine room.

In addition, the mounting bracket includes support columns supporting both distal ends of the fixing shaft.

According to another aspect of the present disclosure, there is provided a rain hat device for heavy construction equipment which is installed adjacent to an exhaust gas discharging port of a distal end portion of an exhaust pipe to prevent inflow of rainwater therein, the rain hat device including a mounting bracket having a fixing shaft which is installed on an upper portion of the exhaust gas discharging port of the distal end portion of the exhaust pipe, the mounting bracket fixing the fixing shaft at a position higher than the distal end portion of the exhaust pipe; and a swing cover having a cover support portion connected to the fixing shaft and extending between the fixing shaft and the exhaust gas discharging port, and a weight portion, in which the cover support portion is rotated around the fixing shaft by pressure of exhaust gas discharged from the distal end portion, wherein the mounting bracket includes support columns supporting both distal ends of the fixing shaft, and the swing cover is installed on an upper portion of the exhaust gas discharging port in a floating state by the cover support portions so that a weight center is positioned between the support columns when the exhaust gas is not discharged from the exhaust gas discharging port.

With the above description, according to the rain hat device for heavy construction equipment, the swing cover is installed on the distal end portion of the exhaust pipe in a floating state, and the weight center of the swing cover is placed below the fixing shaft. Therefore, even though the engine stops or the engine is idling, the swing cover does not contact or collide against the distal end of an exhaust pipe and an exhaust gas discharging port, thereby preventing mechanical noise from being generated repeatedly.

In addition, the height of the fixing shaft is set to be similar to that of the upper portion of the engine room, so that the whole height of the rain hat device can be maintained at a low level lower than the cabin. Therefore, it is possible to eliminate a problem in which work efforts remarkably increase, for example, cumbersome disassembling/assembling process is required for the transport thereof.

### BRIEF DESCRIPTION OF THE DRAWINGS

The above and other objects, features and advantages of the present disclosure will be more apparent from the following detailed description taken in conjunction with the accompanying drawings, in which:

FIG. 1 shows a side view illustrating an excavator of a related art;

FIGS. 2A and 2B are views schematically illustrating a rain hat device for heavy construction equipment according to a related art, in which FIG. 2A is a partial cross-sectional view of a rain hat connected to a distal end of an exhaust pipe, and FIG. 2B is a side view of the rail hat connected to the exhaust pipe shown in FIG. 2A;

FIG. 3 is a view illustrating the operation of the rain hat device for heavy construction equipment according to the related art shown in FIG. 2;

FIGS. 4A to 4D are views illustrating a rain hat device for heavy construction equipment according to an embodiment of the present disclosure, in which FIG. 4A is a front view of the rain hat device for heavy construction equipment according to the present disclosure, FIG. 4B is a left side view of the rain hat device for heavy construction equipment shown in FIG. 4A, FIG. 4C is a right side view of the rain hat device for heavy construction equipment shown in FIG. 4A, and FIG. 4D is a plan view of the rain hat device for heavy construction equipment shown in FIG. 4A;

FIG. 5 is a perspective view illustrating a variation of a weight center G in accordance with a swing operation state of a rain hat device for heavy construction equipment according to the present disclosure;

FIG. 6 is a perspective view illustrating a state in which a rain hat device is installed at a distal end portion of an exhaust pipe, according to an embodiment of the present disclosure;

FIG. 7 is a perspective view illustrating a state in which a rain hat device is installed at an engine room, according to an embodiment of the present disclosure; and

FIG. 8 is a perspective view illustrating an excavator including a rain hat device for heavy construction equipment according to the present disclosure.

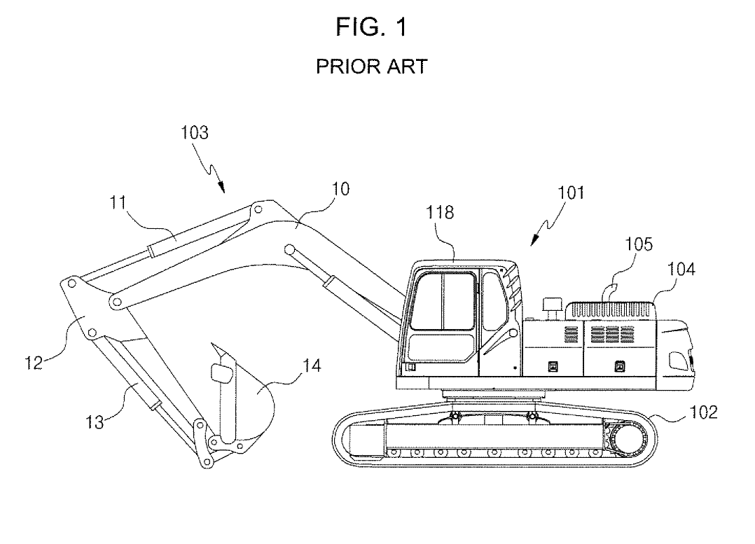

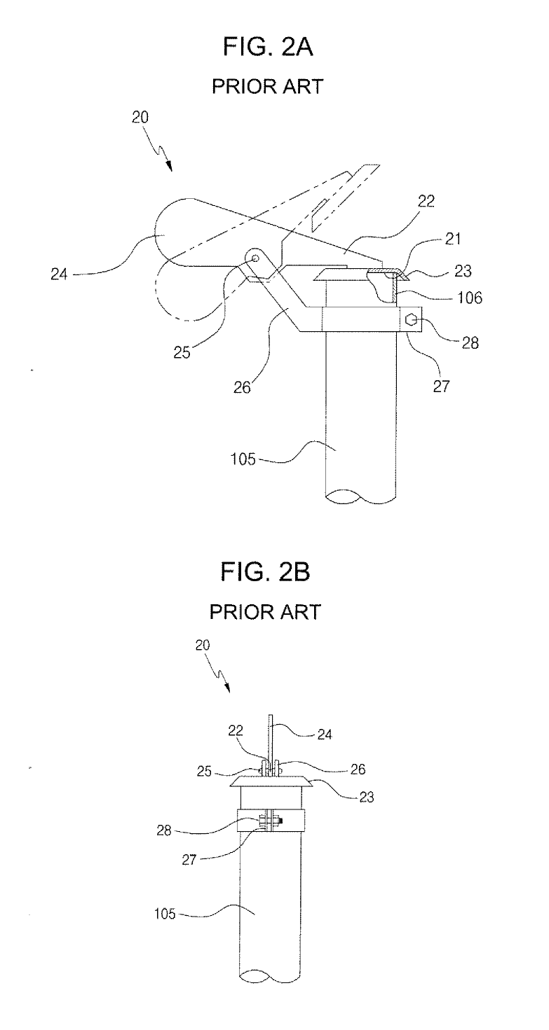

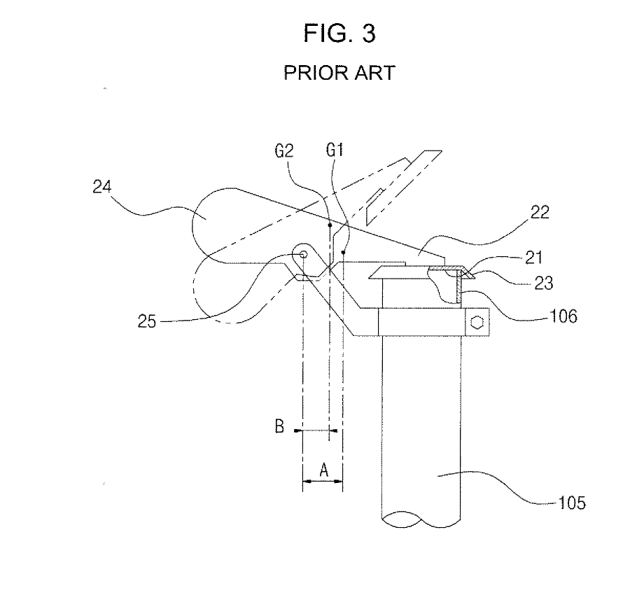

### DETAILED DESCRIPTION OF EXEMPLARY EMBODIMENTS

Hereinafter, exemplary embodiments of the present disclosure will be described with reference to the accompanying drawings. The matters defined in the description, such as the detailed construction and elements, are nothing but specific details provided to assist those of ordinary skill in the art in a comprehensive understanding of the present disclosure, and thus the present disclosure is not limited thereto.

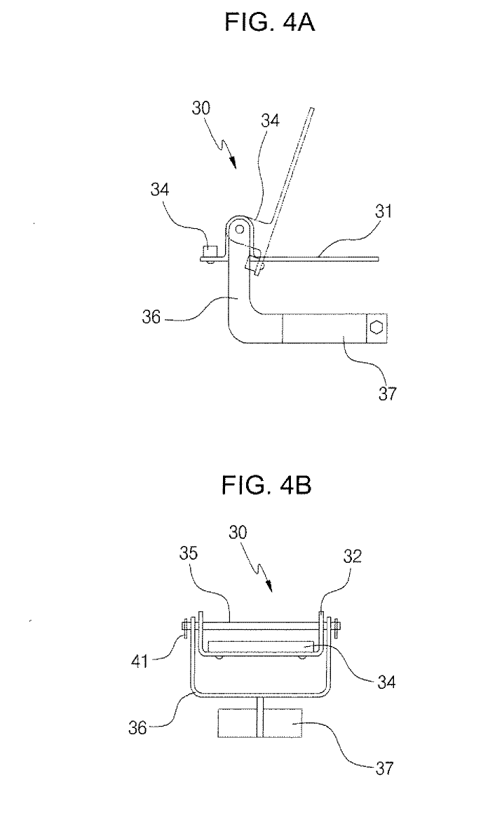

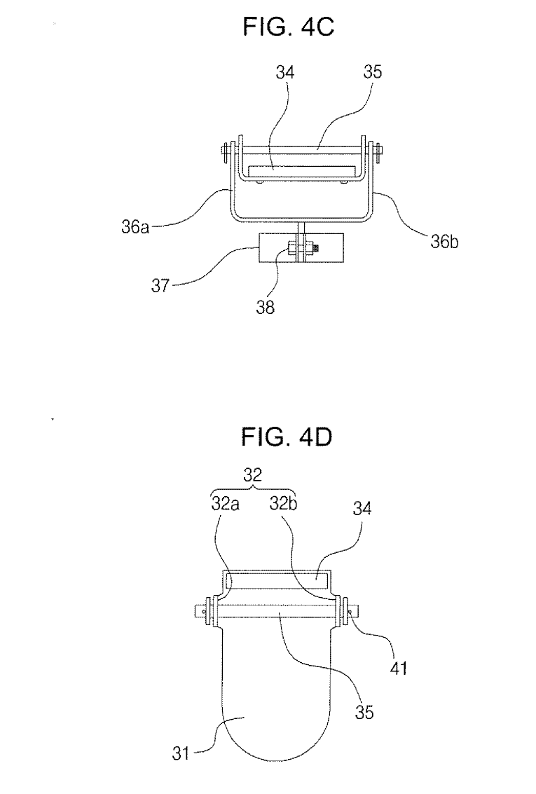

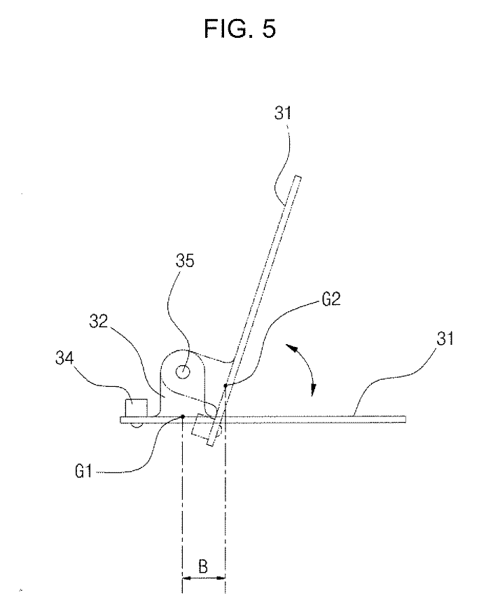

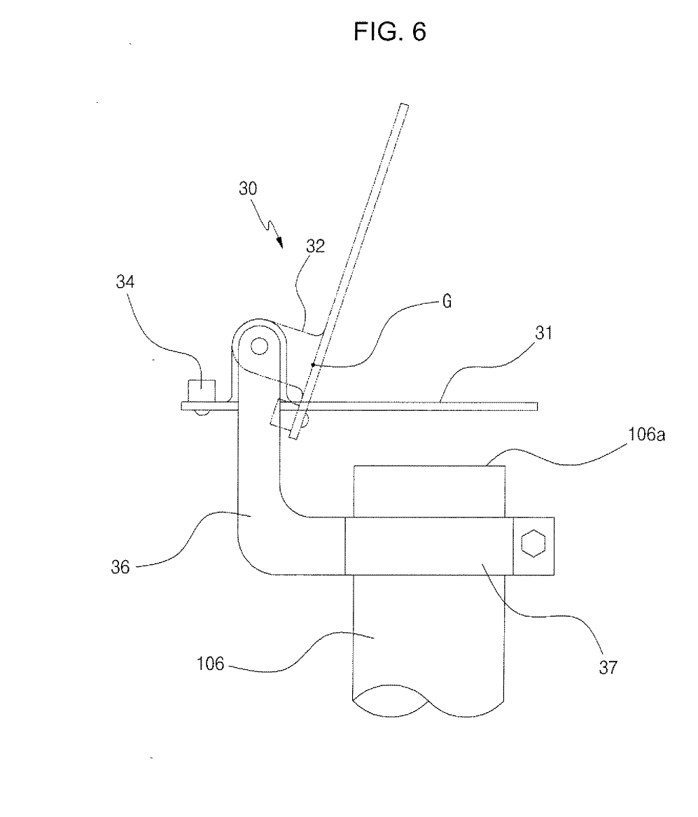

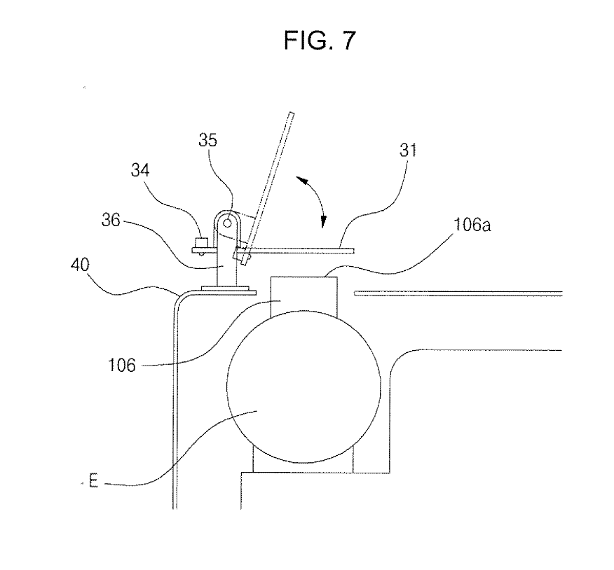

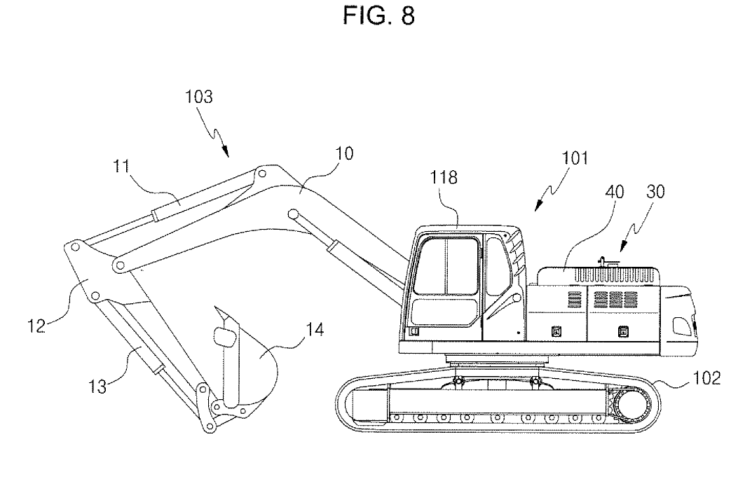

FIGS. 4A to 4D are views illustrating a rain hat device for heavy construction equipment according to an embodiment of the present disclosure, in which FIG. 4A is a front view of the rain hat device for heavy construction equipment according to the present disclosure, FIG. 4B is a left side view of the rain hat device for heavy construction equipment shown in FIG. 4A, FIG. 4C is a right side view of the rain hat device for heavy construction equipment shown in FIG. 4A, and FIG. 4D is a plan view of the rain hat device for heavy construction equipment shown in FIG. 4A. FIG. 5 is a perspective view illustrating a variation of a weight center G in accordance with a swing operation state of the rain hat device for heavy construction equipment according to the present disclosure. FIG. 6 is a perspective view illustrating a state in which the rain hat device is installed at a distal end portion of an exhaust pipe, according to an embodiment of the present disclosure. FIG. 7 is a perspective view illustrating a state in which the rain hat device is installed at an engine room, according to an embodiment of the present disclosure. FIG. 8 is a perspective view illustrating an excavator including the rain hat device for heavy construction equipment according to the present disclosure.

Herein, reference numeral 31 denotes a swing cover, 32, a cover support portion for fixing the swing cover, 35 denotes a fixing shaft, 36 denotes a mounting bracket, G1 denotes a weight center of the swing cover at a normal state, and G2 denotes a weight center of the swing cover which is changed by discharging pressure of exhaust gas.

Referring to FIGS. 4 and 5, the rain hat device for heavy construction equipment according to an embodiment of the present disclosure is installed adjacent to an exhaust gas discharging port 106a of a distal end portion 106 of an exhaust pipe to prevent inflow of rainwater therein.

The rain hat device includes a mounting bracket 36 having a fixing shaft 35 which is installed on an upper portion of the exhaust gas discharging port 106a of the distal end portion 106 of the exhaust pipe, and fixing the fixing shaft 35 at a position higher than the distal end portion 106 of the exhaust pipe; and a swing cover 31 having a cover support portion 32 connected to the fixing shaft 35 and extending between the fixing shaft 35 and the exhaust gas discharging port 106a, and a weight portion 34, in which the cover support portion 32 is rotated around the fixing shaft 35 by pressure of exhaust gas discharged from the distal end portion 106.

The swing cover 31 is installed on an upper portion of the exhaust gas discharging port 106a in a floating state by the cover support portion 32 so that a weight center G is positioned between the fixing shaft 35 and the exhaust gas discharging port 106a when the discharging pressure of the exhaust gas is generated.

The weight portion 34 is welded to one surface of a longitudinal end portion of the swing cover 31 adjacent to the exhaust gas discharging port 106a. In a case where it is fixed by means of bolts, it is preferably configured in such a way that the weight center G of the swing cover 31 which is changed from a position G1 to a position G2 by the discharging pressure of the exhaust gas is positioned below the fixing shaft 35.

The mounting bracket 36 is provided at one side thereof with a clamp member 37 for connecting the mounting bracket to the distal end portion 106 of the exhaust pipe.

The clamp member 37 is closely supported on an outer circumference of the distal end portion 106 of the exhaust pipe, and is mounted on the outer circumference of the distal end portion 106 of the exhaust pipe by a bolting manner or a coupling manner.

According to another embodiment of the present disclosure, the mounting bracket 36 is fixed to one side of the engine room 40. In this instance, the mounting bracket 36 has a function of setting the height of the fixing shaft 35 which is supported on an upper portion of the exhaust gas discharging port 106a of the distal end portion 106 of the exhaust pipe.

As shown in FIG. 4, the mounting bracket 36 includes support columns 36a and 36b connected to both distal ends of the fixing shaft 35, and cover support portions 32a and 32b are rotatably fixed to the fixing shaft 35 between the support columns 36a and 36b.

Alternatively, the rain hat device for heavy construction equipment according to the present disclosure which is installed adjacent to an exhaust gas discharging port 106a of a distal end portion 106 of an exhaust pipe to prevent inflow of rainwater therein, includes a mounting bracket 36 having a fixing shaft 35 which is installed on an upper portion of the exhaust gas discharging port 106a of the distal end portion 106 of the exhaust pipe, and fixing the fixing shaft 35 at a position higher than the distal end portion 106 of the exhaust pipe; and a swing cover 31 having a cover support portion 32 connected to the fixing shaft 35 and extending between the fixing shaft 35 and the exhaust gas discharging port 106a, and a weight portion 34, in which the cover support portion 32 is rotated around the fixing shaft 35 by discharging pressure of exhaust gas discharged from the distal end portion 106, wherein the mounting bracket 36 includes support columns 36a and 36b for supporting both distal ends of the fixing shaft 35, and the swing cover 31 is installed on an upper portion of the exhaust gas discharging port 106a in a floating state by the cover support portions 32a and 32b so that a weight center G is positioned between the support columns 36a and 36b when the exhaust gas is not discharged from the exhaust gas discharging port 106a.

Preferably, the swing cover 31 is supported by the cover support portions 32a and 32b so that the weight center G is positioned between the support columns 36a and 36b and below the fixing shaft 35 when the exhaust gas is not discharged from the exhaust gas discharging port 106a.

The fixing shaft 35 is provided at both sides thereof with provided a release prevention pin 41 for preventing release of a shaft coupling unit including the cover support portions 32a and 32b, the mounting bracket 36 and the support columns 36a and 36b when the swing cover 31 swings.

The operation of the rain hat device for heavy construction equipment according to an embodiment of the present disclosure will now be described.

Referring to FIGS. 4 and 5, with the rain hat device for heavy construction equipment according to the present disclosure, the clamp member 37 formed on one side of the mounting bracket 36 is connected to an outer circumference of the distal end portion 106 of the exhaust pipe adjacent to the exhaust gas discharging port 106a.

The fixing shaft 35 is installed on the support columns 36a and 36b of the mounting bracket 36, and the upper portion of the cover support portion 32 is connected to the fixing shaft 35, so that the swing cover 31 including the weight 34 is suspended from the fixing shaft 35.

In this instance, the lower portion of the swing cover 31 is fixed to the upper portion of the exhaust gas discharging port 106a by the clamping member 37, and is maintained in a floating state which is spaced apart from the upper portion, thereby preventing rainwater or dust from flowing in the exhaust gas discharging port 106a by the swing cover 31.

The weight center G of the rotating unit including the swing cover 31, the cover support portion 32 and the weight 34 acts vertically with respect to a gravity direction, and thus is set just below the fixing shaft 35 so that the lower portion or a bottom surface of the swing cover 31 is placed in substantially horizontal direction.

For example, if there is no pressure of the exhaust gas discharged from the exhaust gas discharging port 106a at a normal state, the weight center G is set just below the fixing shaft 35. In this instance, the swing cover 31 is placed in a floating state at a desired height from the exhaust gas discharging port 106a.

If the engine suddenly stops or the engine is idling, the weight center G of the swing cover 31 suspended from the fixing shaft 35 is placed at a position closer to the position G1 which is placed below the fixing shaft 35, even though it shakes slightly by slight discharging pressure of the exhaust gas.

It means that the weight center is changed by a dynamic inertial force of the swing cover 31 which is generated by the rotational moment M due to its own weight of the swing cover 31. Even though the inertial force is slightly varied, the weight center G of the swing cover 31 is set below the fixing shaft 35 or between the support columns 36a and 36b of the mounting bracket 36 as a normal position.

As indicated by an imaginary line in FIGS. 5 and 6, if the exhaust gas is discharged at high pressure from the exhaust gas discharging port 106a by fast revolution of the engine, the swing cover 31 including the cover support portion 32 and the weight 34 is rotated in a counterclockwise direction by the dynamic spraying pressure.

In this instance, the weight center G of the swing cover 32 is moved to a point B in a counterclockwise direction around the fixing shaft 35, so that the weight center is changed to the position G2. As a result, the rotational moment of the swing cover 32 acts in a downward direction, namely, in a gravity direction, as a force of M=W×A.

If the exhaust gas is continuously discharged, the swing cover 31 supported by the cover support portion 32 may intermittently stand erect. However, since the weight portion 34 serves as most of load W below the fixing shaft 35, the weight center G2 of the swing cover 31 is placed under the fixing shaft 35.

After that, if the engine stops, the pressure of the exhaust gas discharged from the exhaust gas discharging port 106a is lowered than the rotational moment M due to its own weight of the swing cover 31, and the swing cover 31 serving as the operating unit is rotated in the clockwise direction around the fixing shaft 35, and is moved in a horizontal direction from the exhaust gas discharging port 106a.

When the swing cover 31 is moved in the horizontal direction, the weight center G of the operating unit is set just below the fixing shaft 35, and the swing cover 31 is maintained in a horizontal state without contacting or colliding against the distal end 106 of the exhaust pipe and the exhaust gas discharging port 106a.

It means that in the state in which the engine stops or the engine is idling, the swing cover 31 does not contact or collide against the distal end 106 of the exhaust pipe and the exhaust gas discharging port 106a, so that mechanical noise such as rattling noise is not generated repeatedly.

As another embodiment of the present disclosure, as shown in FIG. 7, the lower portion of the mounting bracket 36 may be fixed to one side of the upper portion of the engine room 40. In this instance, the swing cover 31 is configured so that it is maintained in a floating state in the air at a position spaced apart from the distal end 106 of the exhaust pipe and the exhaust gas discharging port 106a, similar to the above embodiment.

Consequently, the swing cover 31 can be moved in the counterclockwise direction or clockwise direction around the fixing shaft 35 by the pressure of the exhaust gas discharged from the exhaust gas discharging port 106a. If the engine stops or the exhaust gas is not discharged, the weight center G is set usually below the fixing shaft 35 by the rotational moment M of the operating unit including the swing cover 31, the cover support portion 32 and the weight 34, similar to the above operating principle.

If the rain hat device for heavy construction equipment according to the present disclosure is applied to a large-sized excavator, the height of the fixing shaft 35 and the clamp member 37 supported by the mounting bracket is set to be similar to that of the upper portion of the engine room, so that the whole height of the rain hat device can be maintained at a low level lower than the cabin. Therefore, it is possible to eliminate a drawback contained in the related art in which work efforts remarkably increase, for example, cumbersome disassembling/assembling process is required for the transport thereof.

Although preferred embodiments of the present disclosure have been described for illustrative purposes, those skilled in the art will appreciate that various modifications, additions and substitutions are possible, without departing from the scope and spirit of the present disclosure as disclosed in the accompanying claims.

1. A rain hat device for heavy construction equipment which is installed adjacent to an exhaust gas discharging port of a distal end portion of an exhaust pipe to prevent inflow of rainwater therein, the rain hat device comprising:
a mounting bracket having a fixing shaft which is installed on an upper portion of the exhaust gas discharging port of the distal end portion of the exhaust pipe, the mounting bracket fixing the fixing shaft at a position higher than the distal end portion of the exhaust pipe; and
a swing cover having a cover support portion connected to the fixing shaft and extending between the fixing shaft and the exhaust gas discharging port, and a weight portion, in which the cover support portion is rotated around the fixing shaft by pressure of exhaust gas discharged from the distal end portion;
wherein the swing cover is installed on an upper portion of the exhaust gas discharging port in a floating state by the cover support portion so that a weight center is positioned between the fixing shaft and the exhaust gas discharging port when the discharging pressure of the exhaust gas is generated.

2. The rain hat device according to claim 1, wherein the mounting bracket is provided at one side thereof with a clamp member for connecting the mounting bracket to the distal end portion of the exhaust pipe.

3. The rain hat device according to claim 1, wherein the mounting bracket is fixed to one side of an engine room.

4. The rain hat device according to claim 1, wherein the mounting bracket includes support columns supporting both distal ends of the fixing shaft.

5. A rain hat device for heavy construction equipment which is installed adjacent to an exhaust gas discharging port of a distal end portion of an exhaust pipe to prevent inflow of rainwater therein, the rain hat device comprising:
a mounting bracket having a fixing shaft which is installed on an upper portion of the exhaust gas discharging port of the distal end portion of the exhaust pipe, the mounting bracket fixing the fixing shaft at a position higher than the distal end portion of the exhaust pipe; and
a swing cover having a cover support portion connected to the fixing shaft and extending between the fixing shaft and the exhaust gas discharging port, and a weight portion, in which the cover support portion is rotated around the fixing shaft by pressure of exhaust gas discharged from the distal end portion;
wherein the mounting bracket includes support columns supporting both distal ends of the fixing shaft; and
the swing cover is installed on an upper portion of the exhaust gas discharging port in a floating state by the cover support portions so that a weight center is positioned between the support columns when the exhaust gas is not discharged from the exhaust gas discharging port.
